(19) United States
(12) Patent Application Publication
(10) Pub. No.: US 2025/0208569 A1
(43) Pub. Date: Jun. 26, 2025

(54) ADJUSTMENT SYSTEM FOR A DISPLAY MECHANISM

(71) Applicant: Montres Breguet S.A., L'Abbaye (CH)

(72) Inventor: Jérôme MACÉ, Le Pont (CH)

(73) Assignee: Montres Breguet S.A., L'Abbaye (CH)

(21) Appl. No.: 18/985,793

(22) Filed: Dec. 18, 2024

(30) Foreign Application Priority Data
Dec. 22, 2023 (EP) 23220076.6

(51) Int. Cl. G04B 13/02; G04B 19/21

(52) U.S. Cl. CPC G04B 13/02; G04B 19/21

(57) ABSTRACT

An adjustment system for a display mechanism including a wheel arranged to pivot with an arbor, the wheel having a peripheral part defining a central opening for receiving the arbor; an information display rigidly connected to the peripheral part of the wheel; a friction mechanism having a friction portion at the central opening and including friction zones around the arbor to hold the wheel on the arbor; at least two resiliently deformable arms, the arms connecting the friction portion to the peripheral part of the wheel in order to clamp the arbor and prevent rotation and/or translation of the wheel on the arbor below a predefined force.

### TECHNICAL FIELD OF THE INVENTION

The invention relates to the field of mechanical watchmaking. More particularly, it relates to an adjustment system for a timepiece display mechanism for adjusting the position of an information display means contained in the display mechanism.

### Technological Background

The legibility of displays is a major concern in watchmaking, especially for calendar-type displays, which are difficult to produce in formats that are easily visible and decipherable by the user.

Horological displays are sometimes made using a roller display because the indications in this form are easy to read.

However, it is not always easy to achieve a correct adjustment between the different components as seen by the wearer, in order to achieve a high-quality visual effect.

### SUMMARY OF THE INVENTION

The main purpose of the invention is to overcome the various drawbacks of the prior art.

The aim of the invention is to be able to adjust the position of information display means axially to ensure the information displayed is in alignment, and radially to equalise play between two information display means.

Another aim of the invention is to provide an adjustment system that allows for simple, quick and precise adjustment of the display means without having to access the shaft supporting the display means.

To this end, the present invention relates to an adjustment system for a display mechanism comprising:
a wheel arranged to pivot with an arbor, the wheel having a peripheral part defining a central opening for receiving the arbor;
means for displaying information, which means are rigidly connected to the peripheral part of the wheel;

According to the invention, the system comprises friction means, the friction means comprising:
a friction portion at the central opening and comprising friction zones around the arbor to hold the wheel on the arbor;
at least two resiliently deformable arms, the arms connecting the friction portion to the peripheral part of the wheel in order to clamp the arbor and prevent rotation and/or translation of the wheel on the arbor below a predefined force.

According to other advantageous alternative embodiments of the invention:
the two resilient arms extend parallel to each other;
the friction portion has an arcuate shape arranged to cooperate with a radial bearing surface of the arbor;
the peripheral part of the wheel comprises means for attaching a display member;
the wheel has stops for correctly positioning the display member relative to the attachment means;
the friction portion has a thickness greater than the thickness of the arms and of the peripheral part.

The invention further relates to a horological movement and to a timepiece comprising a friction system according to the invention.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows an exploded perspective view of a system according to the invention;

FIG. 2 shows an assembled view of a system according to the invention.

### DETAILED DESCRIPTION OF THE INVENTION

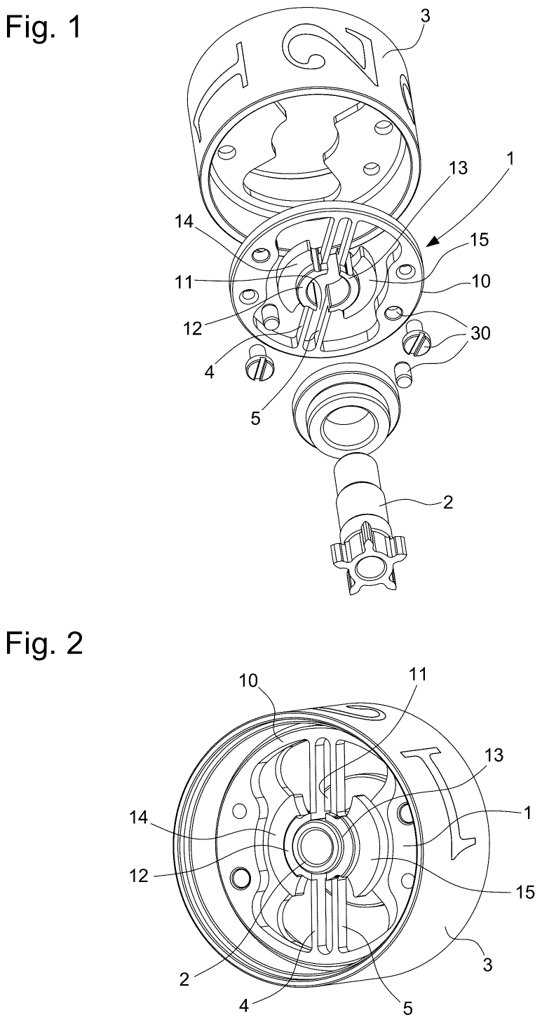

FIG. 1 shows a friction system 100 according to the invention. This system comprises a shaft 1 arranged to be mounted in a horological movement, which shaft can comprise parts with sections 10, 11 of different diameters.

FIG. 2 illustrates an adjustment system 1 for a display mechanism 100 of a timepiece according to one embodiment of the invention. The display mechanism 100 can, for example, be a mechanism of the timepiece for displaying the time, date, day, date or moon phase.

The adjustment system for a display mechanism comprises in particular a wheel 1 arranged to pivot with an arbor 2, the wheel having a peripheral part 10 defining a circular central opening 11 for receiving the arbor 2. It should also be noted that the peripheral part 10 supports information display means 3, which means are rigidly connected to the peripheral part 10 of the wheel 1.

According to the invention, the wheel comprises friction means which have a friction portion at the central opening 11, the friction portion comprising friction zones 12, 13 around the arbor 2 to hold the wheel on the arbor.

The friction means further comprise at least two resiliently deformable arms 4, 5, the arms connecting the friction portion to the peripheral part 10 of the wheel 1 in order to clamp the arbor 2 and prevent the wheel 1 from rotating about the arbor 2 below a predefined torque.

The wheel 1, the friction portion and the resiliently deformable arms 4, 5 advantageously take the form of a one-piece component. The resiliently deformable arms 4, 5 each have two opposite ends by which they are connected to the wheel 1. Such a connection allows for optimum transmission of forces and stresses between these two elements, whether this involves tensile, compressive, bending, torsional or shear forces or stresses.

As can be seen in FIG. 1, the wheel 1 comprises a first resiliently deformable arm 4 and a second resiliently deformable arm 5 extending substantially parallel to the first arm, inside the wheel, and on either side of the central opening 11.

The two resiliently deformable arms 4, 5 are intended to extend on either side of the arbor 2 arranged to drive the wheel 1 rotatably, and together form a clamping means capable of clamping a radial bearing surface of the arbor 2, the friction portion having an arcuate shape to optimise the friction surface with the arbor 2. Similarly, the friction portion can have a thickness greater than the thickness of the arms 4, 5 and of the peripheral part of the wheel to increase the contact surface with the arbor 2 and thus increase the friction surface.

Thus, it is possible to adjust the axial and radial position of the wheel 1 on the arbor 2 by exerting a force greater than the frictional force holding the wheel on the arbor. Such an adjustment system is particularly useful for a roller display, in particular to easily adjust the correct positioning of one roller in relation to another roller and to ensure perfect alignment of the information on each of the rollers.

According to an alternative embodiment of the invention not shown, the means for clamping the arbor 2 could comprise a larger number of resiliently deformable arms. For example, it could comprise four arms arranged about the arbor 2.

As can be seen from the figures, the wheel 1 comprises attachment means 30 arranged in the vicinity of the peripheral part 10 to rigidly connect the information display means to the wheel 1. The wheel 1 further comprises stops 14, 15 to ensure that the display means 3 are correctly positioned relative to the attachment means.

Although the figures illustrate display means in the form of a roller, other display shapes can be envisaged, such as a hexagonal or octagonal shape, for example.

Such an adjustment system thus allows the position of information display means, such as rollers, to be axially adjusted to ensure the information displayed is in alignment, and radially adjusted to equalise play between two information display means.

This adjustment system is particularly advantageous because the watchmaker can adjust the position without having access to the shaft about which the display means rotate. Therefore, in order to correct the position, the watchmaker simply has to manipulate the display means by exerting a force greater than the frictional force.

It goes without saying that the present invention is not limited to the example shown and that various alternatives and modifications that may be apparent to a person skilled in the art can be made thereto, while still remaining within the scope of the invention as defined by the claims.

1. An adjustment system for a display mechanism, which system comprises:
a wheel arranged to pivot with an arbor, the wheel having a peripheral part defining a central opening for receiving the arbor;
means for displaying information, which means are rigidly connected to the peripheral part of the wheel;
friction means, the friction means comprising:
a friction portion at the central opening and comprising friction zones around the arbor to hold the wheel on the arbor;
at least two resiliently deformable arms, the arms connecting the friction portion to the peripheral part of the wheel in order to clamp the arbor and prevent rotation and/or translation of the wheel on the arbor below a predefined force.

2. The system according to claim 1, wherein the two resilient arms extend parallel to each other.

3. The system according to claim 1, wherein the friction portion has an arcuate shape arranged to cooperate with a radial bearing surface of the arbor.

4. The system according to claim 1, wherein the peripheral part of the wheel comprises means for attaching a display member.

5. The system according to claim 4, wherein the wheel has stops for correctly positioning the display member relative to the attachment means.

6. The system according to claim 1, wherein the friction portion has a thickness greater than the thickness of the arms and of the peripheral part.

7. A horological movement comprising an adjustment system according to claim 1.

8. A timepiece comprising a horological movement according to claim 7.
